(19) United States
(12) Patent Application Publication
(10) Pub. No.: US 2015/0116544 A1
(43) Pub. Date: Apr. 30, 2015

(54) METHOD AND APPARATUS OF WORKING MODE CONTROL, AND ELECTRONIC DEVICE

(71) Applicant: Sony Corporation, Tokyo (JP)

(72) Inventors: Gang XU, Beijing (CN); Zhong LI, Beijing (CN); Hairong HUANG, Beijing (CN); Zhannian GAO, Beijing (CN); Hongxing YU, Beijing (CN); Tao ZHOU, Beijing (CN)

(73) Assignee: Sony Corporation, Tokyo (JP)

(21) Appl. No.: 14/230,336

(22) Filed: Mar. 31, 2014

(30) Foreign Application Priority Data
Oct. 31, 2013 (CN) 201310530253.5

(51) Int. Cl. H04N 5/235

(52) U.S. Cl. CPC H04N 5/2351
USPC 348/234

(57) ABSTRACT

The embodiments of the present invention provide a method and an apparatus for controlling a working mode, and an electronic device. The method for controlling the working mode comprises: detecting, by an electronic device, an intensity of light entering a first camera; and switching, by the electronic device, the working mode, when detecting that a change of the intensity of light entering the first camera meets a first preset condition. The embodiments of the present invention can simplify the operation steps of the electronic device, and quickly and conveniently switch the working mode of the electronic device, such that the user obtains better experiences.

### CROSS-REFERENCE TO RELATED APPLICATION AND PRIORITY CLAIM

This application claims priority from Chinese patent application No. 201310530253.5, filed Oct. 31, 2013, the entire disclosure of which hereby is incorporated by reference.

### TECHNICAL FIELD

The present invention relates to an image processing technology, and particularly, to a method and an apparatus for controlling a working mode, and an electronic device.

### BACKGROUND

With development of technologies, more and more electronic devices have a shooting function. In order that a user views recently shot images or videos, existing smart phones and digital cameras all have review functions. Moreover, in order to facilitate the user's shooting, more and more smart phones and digital cameras are each provided with a plurality of cameras, such as a front camera and a rear camera.

Currently, a conventional way for realizing the review function is to provide a review button and a back key on the electronic device. When the user wants to review a photograph, the recently shot images or videos can be displayed by pressing the review button, and when the user wants to take a photograph again, the back key is pressed to switch to the shooting mode. In order to realize the function of multi-camera switched shooting of the electronic device, the conventional way is to provide a switching button key on the electronic device. For example, when the user wants to shoot with the front camera, the electronic device can be switched from using the rear camera to using the front camera by pressing the switching button key.

To be noted, the above introduction to the technical background is just made for the convenience of clearly and completely describing the technical solutions of the present invention, and to facilitate the understanding of a person skilled in the art. It shall not be deemed that the above technical solutions are known to a person skilled in the art just because they have been illustrated in the Background section of the present invention.

### SUMMARY

However, the inventor finds that during the shooting process using the electronic device, it is very inconvenient for the user to switch the working mode of the electronic device through a key, and the user's experience is poor. In addition, the key provided on the electronic device also increases the cost of manufacturing the electronic device, and too many keys will also influence the appearance of the electronic device.

The embodiments of the present invention provide a method and an apparatus for controlling a working mode and an electronic device. The objective is to simplify operation steps of the electronic device, and quickly and conveniently switch the working mode of the electronic device, such that the user obtains better experiences.

According to an aspect of an embodiment of the present invention, a method for controlling a working mode is provided, including:

detecting, by an electronic device, an intensity of light entering a first camera; and

switching, by the electronic device, the working mode, when detecting that a change of the intensity of light entering the first camera meets a first preset condition.

According to another aspect of an embodiment of the present invention, wherein the change of the intensity of light entering the first camera meets the first preset condition includes: the intensity of light entering the first camera dims and the intensity of light is lower than a first threshold;

the electronic device is in a shooting mode; switching, by the electronic device, the working mode includes: switching, by the electronic device, from the shooting mode to a review mode.

According to another aspect of an embodiment of the present invention, wherein the change of the intensity of light entering the first camera meets the first preset condition includes: the intensity of light entering the first camera brightens and the intensity of light is higher than a second threshold;

the electronic device is in a review mode; switching, by the electronic device, the working mode includes: switching, by the electronic device, from the review mode to a shooting mode.

According to another aspect of an embodiment of the present invention, wherein detecting, by the electronic device, the intensity of light entering the first camera includes:

detecting, by the electronic device, RGB values of pixels in an image formed at a photosensitive element, a histogram or a gray scale map of the image formed at the photosensitive element, or Auto Exposure (AE) level, so as to obtain the intensity of light entering the first camera.

According to another aspect of an embodiment of the present invention, the method further includes:

judging, by the electronic device, whether a duration of the change of the intensity of light entering the first camera exceeds a first preset time; and

switching, by the electronic device, the working mode, when detecting that the change of the intensity of light entering the first camera meets the first preset condition, and the duration of the change of the intensity of light exceeds the first preset time.

According to another aspect of an embodiment of the present invention, the change of the intensity of light entering the first camera is caused by the user by shading the first camera with an opaque object.

According to another aspect of an embodiment of the present invention, the method further includes:

switching, by the electronic device, from the working mode using the first camera to a working mode using a second camera, when detecting that the change of the intensity of light entering the first camera meets a second preset condition.

According to another aspect of an embodiment of the present invention, wherein the change of the intensity of light entering the first camera meets the second preset condition specifically includes: the intensity of light entering the first camera dims and then brightens, and a duration of dimming exceeds a second preset time.

According to another aspect of an embodiment of the present invention, a method for controlling a working mode is provided, including:

detecting, by an electronic device, an intensity of light entering a first camera; and

switching, by the electronic device, from the working mode using the first camera to a working mode using a second camera, when detecting that a change of the intensity of light entering the first camera meets a second preset condition.

According to another aspect of an embodiment of the present invention, wherein the change of the intensity of light entering the first camera meets the second preset condition specifically includes: the intensity of light entering the first camera dims and then brightens, and the duration of dimming exceeds a second preset time.

According to another aspect of an embodiment of the present invention, an apparatus for controlling a working mode is provided, including:

a first detection unit configured to detect an intensity of light entering a first camera; and

a first switching unit configured to switch the working mode when detecting that a change of the intensity of light entering the first camera meets a first preset condition.

According to another aspect of an embodiment of the present invention, when the first detection unit detects that the change of the intensity of light entering the first camera meets the first preset condition means that the intensity of light entering the first camera dims and the intensity of light is lower than a first threshold, and the electronic device is in a shooting mode, the first switching unit is configured to switch the electronic device from the shooting mode to a review mode.

According to another aspect of an embodiment of the present invention, when the first detection unit detects that the change of the intensity of light entering the first camera meets the first preset condition means that the intensity of light entering the first camera brightens and the intensity of light is higher than a second threshold, and the electronic device is in a review mode, the first switching unit is configured to switch the electronic device from the review mode to a shooting mode.

According to another aspect of an embodiment of the present invention, the first detection unit detects RGB values of pixels in an image formed at a photosensitive element, a histogram or a gray scale map of the image formed at the photosensitive element, or Auto Exposure (AE) level, so as to obtain the intensity of light entering the first camera.

According to another aspect of an embodiment of the present invention, the apparatus further includes:

a judging unit configured to judge whether a duration of the change of the intensity of light entering the first camera exceeds a first preset time;

the first switching unit is further configured to switch the working mode, when the first detection unit detects that the change of the intensity of light entering the first camera meets the first preset condition and a judging result of the judging unit is Yes.

According to another aspect of an embodiment of the present invention, the apparatus further includes:

a second switching unit configured to switch the electronic device from the working mode using the first camera to a working mode using a second camera, when detecting that the change of the intensity of light entering the first camera meets a second preset condition.

According to another aspect of an embodiment of the present invention, wherein the change of the intensity of light entering the first camera meets the second preset condition specifically includes: the intensity of light entering the first camera dims and then brightens, and a duration of dimming exceeds a second preset time.

According to another aspect of an embodiment of the present invention, an apparatus for controlling a working mode is provided, including:

a second detection unit configured to detect an intensity of light entering a first camera; and

a second switching unit configured to switch the electronic device from the working mode using the first camera to a working mode using a second camera, when the second detection unit detects that a change of the intensity of light entering the first camera meets a second preset condition.

According to another aspect of an embodiment of the present invention, wherein the change of the intensity of light entering the first camera meets the second preset condition specifically includes: the intensity of light entering the first camera dims and then brightens, and a duration of dimming exceeds a second preset time.

According to another aspect of an embodiment of the present invention, an electronic device is provided, further including the aforementioned apparatus for controlling the working mode.

The embodiments of the present invention have the following beneficial effect: the intensity of light entering the first camera is detected through the electronic device; and when it is detected that the change of the intensity of light entering the first camera meets the first preset condition, the electronic device switches the working mode, thereby simplifying the operation steps of the electronic device, and quickly and conveniently switching the working mode of the electronic device, such that the user obtains better experiences.

These and other aspects of the present invention will be clear with reference to the subsequent descriptions and drawings, which specifically disclose the particular embodiments of the present invention to indicate some implementations of the principle of the present invention. But it shall be appreciated that the scope of the present invention is not limited thereto, and the present invention includes all the changes, modifications and equivalents falling within the scope of the spirit and the connotations of the accompanied claims.

Features described and/or illustrated with respect to one embodiment can be used in one or more other embodiments in a same or similar way, and/or by being combined with or replacing the features in other embodiments.

To be noted, the term “comprise/include” used herein specifies the presence of feature, element, step or component, not excluding the presence or addition of one or more other features, elements, steps or components or combinations thereof.

Many aspects of the present invention will be understood better with reference to the following drawings. The components in the drawings are not surely drafted in proportion, and the emphasis lies in clearly illustrating the principles of the present invention. For the convenience of illustrating and describing some portions of the present invention, corresponding portions in the drawings may be enlarged, e.g., being more enlarged relative to other portions than the situation in the exemplary device practically manufactured according to the present invention. The parts and features illustrated in one drawing or embodiment of the present invention may be combined with the parts and features illustrated in one or more other drawings or embodiments. In addition, the same reference signs denote corresponding portions throughout the drawings, and they can be used to denote the same or similar portions in more than one embodiment.

### BRIEF DESCRIPTION OF THE DRAWINGS

The included drawings provide further understanding of the present invention, and they constitute a part of the Specification. The drawings illustrate the preferred embodiments of the present invention, and explain the principles of the present invention together with the text, wherein the same element is always denoted with the same reference sign.

In which:

FIG. 1 is a flowchart of a method for controlling a working mode according to Embodiment 1 of the present invention;

FIG. 2 is a schematic diagram of an electronic device in a shooting mode according to Embodiment 1 of the present invention;

FIGS. 3A and 3B are schematic front and side view diagrams of an electronic device switched from a shooting mode to a review mode according to Embodiment 1 of the present invention;

FIGS. 4A and 4B are schematic front and side view diagrams of an electronic device switched from a review mode to a shooting mode according to Embodiment 1 of the present invention;

FIG. 5 is a flowchart of a method for controlling a working mode according to Embodiment 1 of the present invention;

FIG. 6 is a flowchart of a method for controlling a working mode according to Embodiment 2 of the present invention;

FIG. 7 is a schematic diagram of an electronic device using a main camera in a shooting mode according to Embodiment 2 of the present invention;

FIG. 8 is another schematic diagram of an electronic device using a main camera in a shooting mode according to Embodiment 2 of the present invention;

FIG. 9 is another schematic diagram of an electronic device using a main camera in a shooting mode according to Embodiment 2 of the present invention;

FIG. 10 is a schematic diagram of an electronic device switching a working mode from using a main camera to a sub camera according to Embodiment 2 of the present invention;

FIG. 11 is a schematic diagram of an electronic device switching a working mode from using a sub camera to a main camera according to Embodiment 2 of the present invention;

FIG. 12 is a flowchart of a method for controlling a working mode according to Embodiment 2 of the present invention;

FIG. 13 is a flowchart of a method for controlling a working mode according to Embodiment 3 of the present invention;

FIG. 14 is a structure diagram of an apparatus for controlling a working mode according to Embodiment 4 of the present invention;

FIG. 15 is a structure diagram of an apparatus for controlling a working mode according to Embodiment 5 of the present invention;

FIG. 16 is a structure diagram of an apparatus for controlling a working mode according to Embodiment 6 of the present invention; and

FIG. 17 is a block diagram of a system structure of an electronic device according to an embodiment of the present invention.

### DESCRIPTION OF THE EMBODIMENTS

The interchangeable terms “electronic device” and “electronic apparatus” include a portable radio communication device. The term “portable radio communication device”, which is hereinafter referred to as “mobile radio terminal”, “portable electronic apparatus”, or “portable communication apparatus”, includes all devices such as mobile phone, pager, communication apparatus, electronic organizer, personal digital assistant (PDA), smart phone, portable communication apparatus, etc. In the present application, the embodiments of the present invention are mainly described with respect to a portable electronic apparatus in the form of a mobile phone (also referred to as “cellular phone”). However, it shall be appreciated that the present invention is not limited to the case of the mobile phone and it may relate to any type of appropriate electronic device, such as media player, gaming device, PDA, computer, digital camera, tablet computer, etc.

### Embodiment 1

Embodiment 1 of the present invention provides a control method of a working mode. FIG. 1 is a flowchart of a method for controlling a working mode according to Embodiment 1 of the present invention. As illustrated in FIG. 1, the method includes:

Step 101: an electronic device detects an intensity of light entering a first camera;

Step 102: the electronic device switches the working mode when detecting that a change of the intensity of light entering the first camera meets a first preset condition.

In this embodiment, the electronic device for example may be, but not limited to, a camera, a smart phone, or a tablet PC. The electronic device may control the first camera. The first camera may be provided in the electronic device, such as a front camera of the smart phone. The first camera may also be removably integrated with the electronic device through an interface. In addition, the first camera may be further connected to the electronic device wiredly or wirelessly, such as being controlled by the electronic device through WiFi. The present invention is not limited thereto, and the electronic device may be connected to the first camera in another way. The following description is only made through an example where the first camera is provided in the electronic device.

In this embodiment, the working mode of the electronic device may be a shooting mode, a review mode, an editing mode, a sending mode, etc. The various working modes may be switched to each other, and for the specific content or techniques thereof, please refer to the prior art. The present invention is not limited thereto, and other working mode may also be adopted. The following description is only made through an example where the switching is performed between the shooting mode and the review mode.

In step 101, the electronic device may detect the RGB values of pixels in an image formed at a photosensitive element (e.g., CCD image sensor, CMOS image sensor, etc.), a histogram or a gray scale map of the image formed at the photosensitive element, or Auto Exposure (AE) Level, so as to obtain the intensity of light entering the first camera. But in the embodiment, the detection of the intensity of light is not limited to the above way. For example, the intensity of light entering the first camera may also be detected by providing a dedicated optical sensor, and the specific way for the detection may be determined according to the actual situation.

In one embodiment, in step 102, the change of the intensity of light entering the first camera meets the first preset condition may include: the intensity of light entering the first camera dims and the intensity of light is lower than a first threshold.

In this embodiment, when the first preset condition is met as above and the electronic device is in the shooting mode, the electronic device switches the working mode including: the electronic device switches from the shooting mode to the review mode.

In which, the first threshold may be set according to the actual requirement, and it is not limited in this embodiment.

In another embodiment, in step 102, the change of the intensity of light entering the first camera meets the first preset condition may include: the intensity of light entering the first camera brightens and the intensity of light is higher than a second threshold.

In this embodiment, when the first preset condition is met as above and the electronic device is in the review mode, the electronic device switches the working mode including: the electronic device switches from the review mode to the shooting mode.

In which, the second threshold may be set according to the actual requirement, and it is not limited in this embodiment.

In this embodiment, in order to further improve the switching accuracy of the working mode and the error-tolerant rate, before step 102, the method may further include: judging whether a duration of the change of the intensity of light entering the first camera exceeds a first preset time.

In which, the electronic device switches the working mode when detecting that the change of the intensity of light entering the first camera meets the first preset condition, and the duration of the change of the intensity of light exceeds the first preset time.

In which, the first preset time may be set according to the actual requirement, and it is not limited in this embodiment.

In this embodiment, the change of the intensity of light entering the first camera may be caused by the user by shading the first camera with an opaque object, such as a hand, an opaque baffle, a wall, etc., which is not limited herein. In the following description, the opaque object for example is a palm.

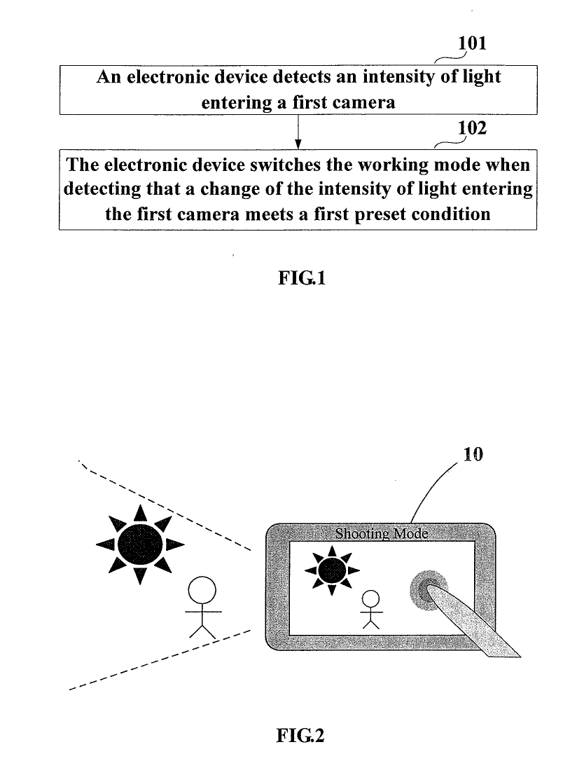

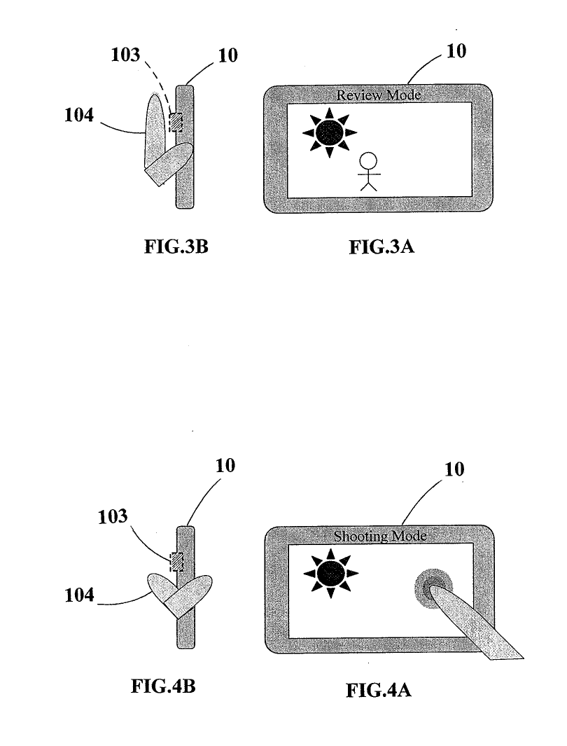

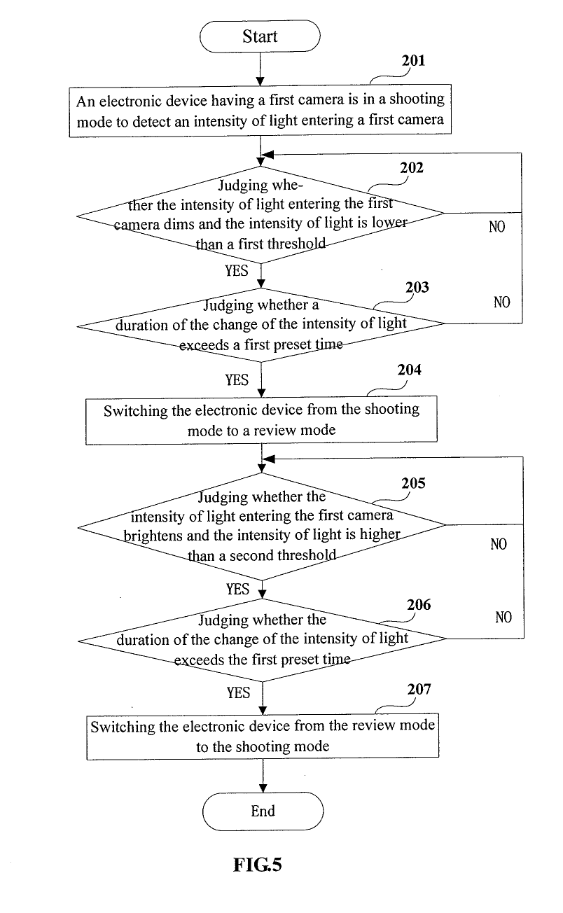

FIG. 2 is a schematic diagram of an electronic device 10 in a shooting mode according to Embodiment 1 of the present invention; FIG. 3 is a schematic diagram of an electronic device switched from a shooting mode to a review mode according to Embodiment 1 of the present invention; and FIG. 4 is a schematic diagram of an electronic device switched from a review mode to a shooting mode according to Embodiment 1 of the present invention.

For example, as illustrated in FIG. 2, after shooting a landscape with a smart phone having a first camera 103, the user wants to view the photograph just shot; as illustrated in FIG. 3, the user may shade the first camera 103 with his palm 104 for more than a first preset time; in that case, the intensity of light entering the first camera dims and the intensity of light is lower than a first threshold, then the smart phone automatically switches from the shooting mode to the review mode.

Next, as illustrated in FIG. 4, the user may remove his palm 104 from the first camera 103, and when the intensity of light entering the first camera brightens, the intensity of light is higher than a second threshold, and the duration of the change exceeds the first preset time, the smart phone automatically switches from the review mode to the shooting mode. Thus, the working mode of the smart phone can be conveniently switched.

FIG. 5 is a flowchart of a switching of a working mode according to Embodiment 1 of the present invention, which takes the switching between the shooting mode and the review mode as an example. As illustrated in FIG. 5, the method includes:

Step 201: an electronic device having a first camera is in the shooting mode to detect an intensity of light entering the first camera;

Step 202: judging whether the intensity of light entering the first camera dims and the intensity of light is lower than a first threshold; if yes, performing step 203, and if no, performing step 202;

Step 203: judging whether a duration of the change of the intensity of light exceeds a first preset time; if yes, performing step 204, and if no, performing step 202;

Step 204: switching the electronic device from the shooting mode to the review mode;

Step 205: judging whether the intensity of light entering the first camera brightens and the intensity of light is higher than a second threshold; if yes, performing step 206, and if no, performing step 205;

Step 206: judging whether the duration of the change of the intensity of light exceeds the first preset time; if yes, performing step 207, and if no, performing step 205;

Step 207: switching the electronic device from the review mode to the shooting mode.

In this embodiment, the user may set different first preset conditions and the switching of the working mode according to the actual requirement, e.g., on-demand in implementation or as desired or required for the current condition or implementation, which are not limited herein. In addition, the first threshold and the second threshold may be the same as or different from each other. To be noted, FIG. 5 only illustrates an example of the switching between the shooting mode and the review mode, and the present invention is not limited thereto. In addition, the judging condition in FIG. 5 is also not limited thereto, e.g., steps 203 and 206 may be omitted. The specific implementation may be determined according to the actual or current situation.

As can be seen from the above method of this embodiment, the intensity of light entering the first camera is detected through the electronic device; and when it is detected that the change of the intensity of light entering the first camera meets the preset condition, the electronic device switches between the shooting mode and the review mode, such that the user quickly and conveniently views the shot photographs during the shooting, and obtains better experiences.

### Embodiment 2

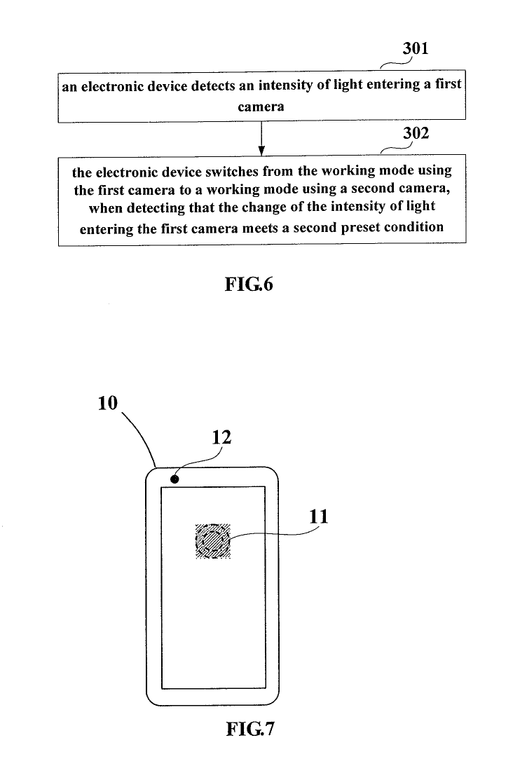

On the basis of Embodiment 1, Embodiment 2 of the present invention provides a method for controlling a working mode to further describe the present invention. FIG. 6 is a flowchart of a method for controlling a working mode according to Embodiment 2 of the present invention. As illustrated in FIG. 6, the method includes:

Step 301: an electronic device detects an intensity of light entering a first camera;

Step 302: the electronic device switches from the working mode using the first camera to a working mode using a second camera, when detecting that the change of the intensity of light entering the first camera meets a second preset condition.

In this embodiment, the electronic device for example may be, but not limited to, a camera, a smart phone, or a tablet PC. The electronic device may control the first camera and the second camera. In which, the first camera and the second camera may be provided in the electronic device, such as a front camera and a rear camera of the smart phone. The first camera and the second camera may also be removably integrated with the electronic device through interfaces. In addition, the first camera and the second camera may be further connected to the electronic device wiredly or wirelessly, such as being controlled by the electronic device through WiFi connection. The present invention is not limited thereto, and the electronic device may be connected to the first camera and the second camera in another way.

In this embodiment, the first camera and the second camera may be provided in the same way (e.g., both being provided in the electronic device) or differently (e.g., the first camera is provided in the electronic device, while the second camera is connected to the electronic device wiredly or wirelessly).

For example, a smart phone having the first camera may be further provided with the second camera, and the electronic device controls the second camera through WiFi connection. In addition, this embodiment is not limited to the two cameras, and more than two cameras can be operated similarly. For simplicity, the following description is only made through an example where the first camera and the second camera are both provided in the electronic device.

In step 301, the electronic device may detect RGB values of pixels in an image formed at a photosensitive element (e.g., CCD image sensor, CMOS image sensor, etc.), a histogram or a gray scale map of the image formed at the photosensitive element, or AE Level, so as to obtain the intensity of light entering the first camera. But in the embodiment, the detection of the intensity of light is not limited to the above way. For example, the intensity of light entering the first camera may also be detected by providing a dedicated optical sensor, and the specific way for the detection may be determined according to the actual or current situation.

In this embodiment, in step 302, the change of the intensity of light entering the first camera meets the second preset condition may include: the intensity of light entering the first camera dims and then brightens, and a duration of dimming exceeds a second preset time.

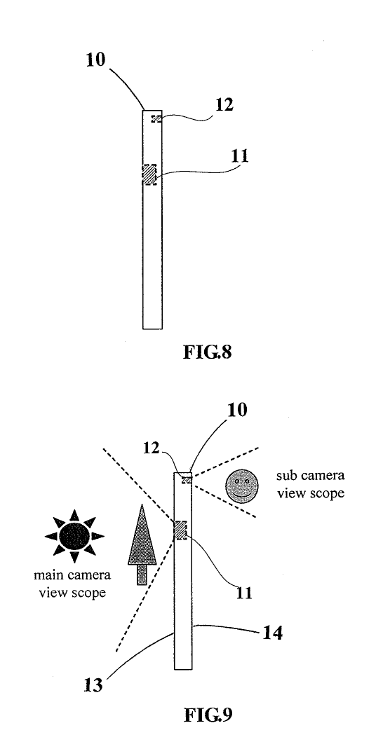

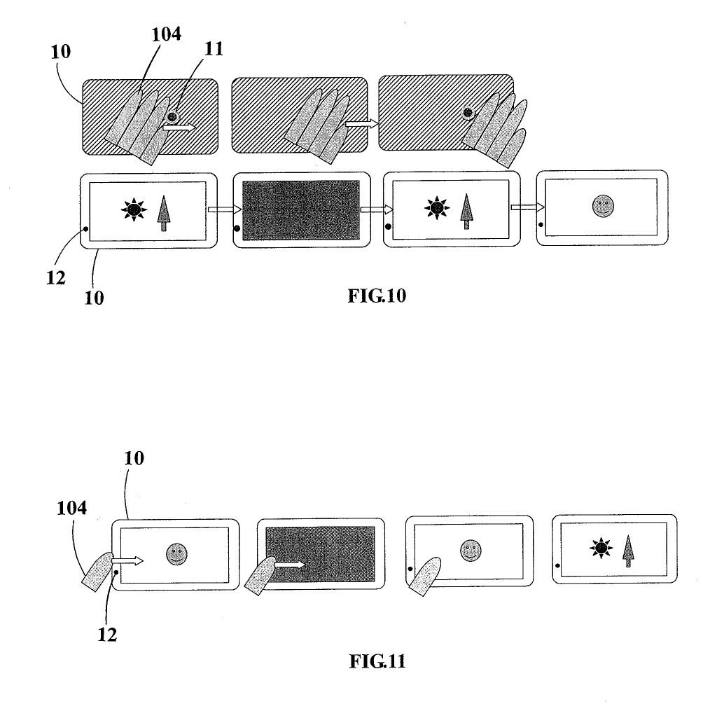

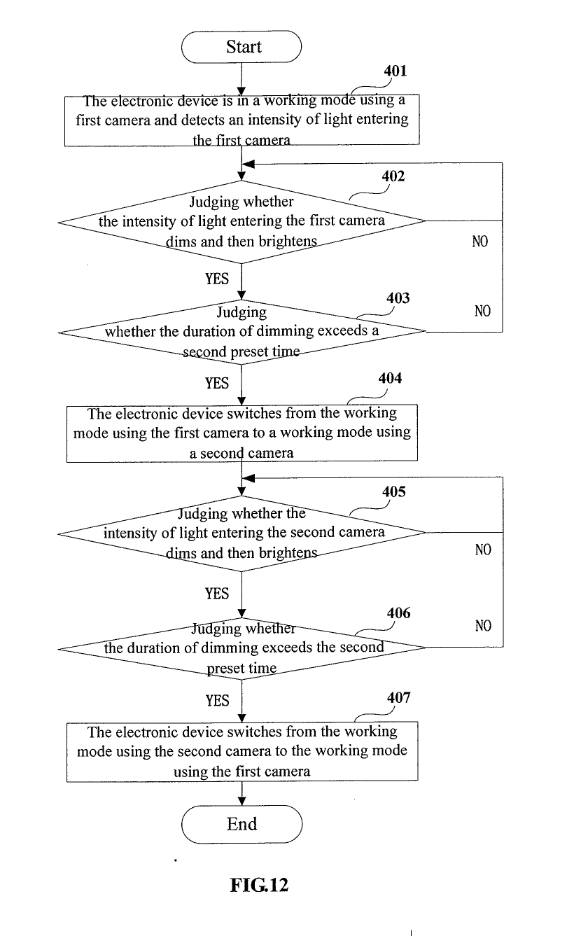

FIG. 7 is a schematic diagram of an electronic device 10 using a main camera 11 in a shooting mode according to Embodiment 2 of the present invention, which illustrates a front view of the electronic device; FIG. 8 is another schematic diagram of an electronic device 10 using a main camera 11 in a shooting mode according to Embodiment 2 of the present invention, which illustrates a side view of the electronic device; and FIG. 9 is another schematic diagram of an electronic device 10 using a main camera in a shooting mode according to Embodiment 2 of the present invention, which illustrates view scope of the cameras of the electronic device.

For example, as illustrated in FIGS. 7-8, a smart phone (electronic device 10) includes a main camera 11 (first camera) and a sub camera 12 (second camera), which are provided at the front 13 and rear 14 sides of the smart phone, respectively, to capture for example landscapes and portraits in different view scope.

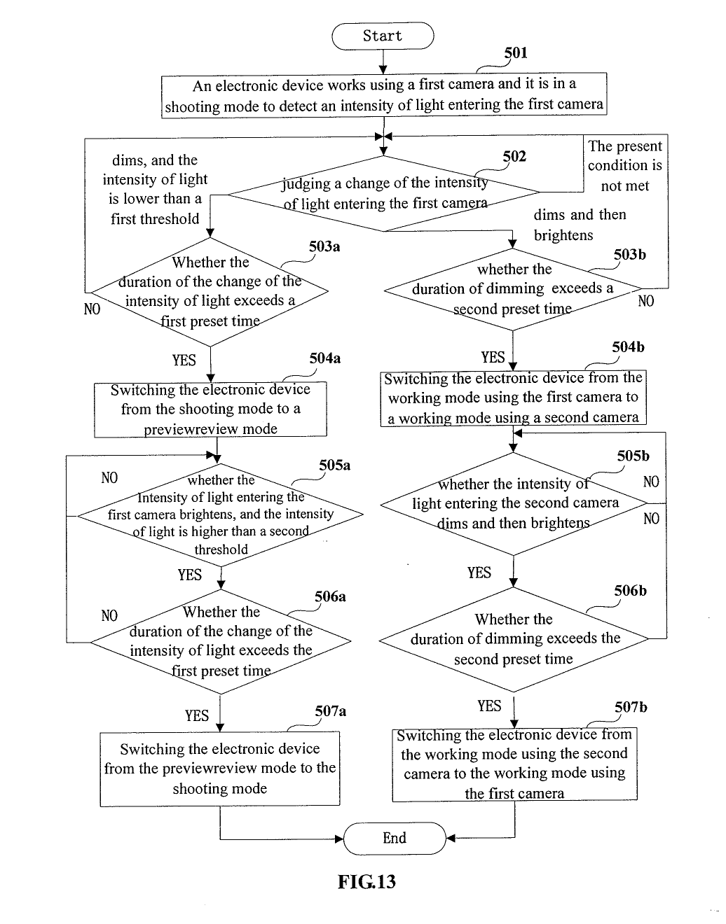

FIG. 10 is a schematic diagram of an electronic device 10 showing steps switching a working mode from using a main camera to a sub camera according to Embodiment 2 of the present invention. FIG. 11 is a schematic diagram of an electronic device 10 showing steps switching a working mode from using a sub camera to a main camera according to Embodiment 2 of the present invention.

As illustrated in FIG. 10, when the user wants to shoot with the sub camera 12 of the smart phone 10 after shooting a landscape with the main camera 11, he may cover the main camera with a palm 104 for more than a second preset time and then remove the palm, which is similar to an action where the palm “sweeps up” the main camera. In that case, since the intensity of light entering the main camera dims and then brightens, and the duration of dimming exceeds the second preset time, the smart phone automatically switches from the main camera to the sub camera.

Similarly, as illustrated in FIG. 11, when the user wants to shoot a landscape with the main camera 11 after shooting a portrait with the sub camera 12, he may cover the sub camera with a palm 104 for more than a second preset time and then remove the palm, which is similar to an action where the palm “sweeps up” the sub camera. In that case, since the intensity of light entering the auxiliary camera dims and then brightens, and the duration of dimming exceeds the second preset time, the smart phone 10 automatically switches from the sub camera to the main camera. Thus the smart phone can conveniently switch between the main and sub cameras.

FIG. 12 is a flowchart of a switching of a working mode according to Embodiment 2 of the present invention, which takes the switching between the first camera and the second camera by the electronic device as an example. As illustrated in FIG. 12, the method includes:

Step 401: the electronic device is in the working mode using the first camera and detects an intensity of light entering the first camera;

Step 402: judging whether the intensity of light entering the first camera dims and then brightens; if yes, performing step 403, and if no, performing step 402;

Step 403: judging whether the duration of dimming exceeds a second preset time; if yes, performing step 404, and if no, performing step 402;

Step 404: the electronic device switches from the working mode using the first camera to a working mode using a second camera;

Step 405: judging whether the intensity of light entering the second camera dims and then brightens; if yes, performing step 406, and if no, performing step 405;

Step 406: judging whether the duration of dimming exceeds the second preset time; if yes, performing step 407, and if no, performing step 405;

Step 407: the electronic device switches from the working mode using the second camera to the working mode using the first camera.

In this embodiment, different thresholds may be set to judge whether the intensity of light entering the first camera dims and then brightens. For example, a third threshold and a fourth threshold may be set to judge that the intensity of light dims and then brightens when the intensity of light becomes lower than the third threshold and then higher than the fourth threshold and the duration of the intensity of light lower than the third threshold exceeds the second preset time.

The third threshold, the fourth threshold and the second preset time may be set according to the actual requirement, e.g., on-demand in implementation or as desired or required for the current condition or implementation, and the second preset time may be set as a short time, which are not limited herein.

In this embodiment, the change of the intensity of light entering the first camera may be caused by the user by shading the first camera with an opaque object, such as a hand, an opaque baffle, a wall, etc., which is not limited herein.

To be noted, this embodiment is not limited to the situation that the electronic device has two cameras, and when the electronic device has more than two cameras, different second preset conditions and the switching of the working mode may be according to the actual requirement, e.g., on-demand in implementation or as desired or required for the current condition or implementation, which are not limited herein.

As can be seen from the above method of this embodiment, the intensity of light entering the first camera is detected through the electronic device; and when it is detected that the change of the intensity of light entering the first camera meets the preset condition, the electronic device switches from the working mode using the first camera to the working mode using the second camera, thereby simplifying the operation steps of the electronic device, and quickly and conveniently switching between the cameras of the electronic device for a shooting, such that the user obtains better experiences.

### Embodiment 3

On the basis of Embodiments 1 and 2, Embodiment 3 further describes the present invention, and the same contents are omitted herein.

FIG. 13 is a flowchart of a method for controlling a working mode according to Embodiment 3 of the present invention. As illustrated in FIG. 13, the method includes:

Step 501: the electronic device works using a first camera and it is in a shooting mode to detect an intensity of light entering the first camera;

Step 502: judging a change of the intensity of light entering the first camera; when the intensity of light dims, and the intensity of light is lower than a first threshold, performing step 503, otherwise continuing performing step 502;

Step 503a: judging whether a duration of the change of the intensity of light exceeds a first preset time; if yes, performing step 504a, and if no, performing step 502;

Step 504a: switching the electronic device from the shooting mode to a review mode;

Step 505a: judging whether the intensity of light entering the first camera brightens, and the intensity of light is higher than a second threshold; if yes, performing step 506a, and if no, performing step 505a;

Step 506a: judging whether the duration of the change of the intensity of light exceeds the first preset time; if yes, performing step 507a, and if no, performing step 505a;

Step 507a: switching the electronic device from the review mode to the shooting mode. In this embodiment, if it is judged in step 502 that the intensity of light dims and then brightens, performing step 503b;

Step 503b: judging whether the duration of dimming exceeds a second preset time; if yes, performing step 504b, and if no, performing step 502;

Step 504b: the electronic device switches from the working mode using the first camera to a working mode using a second camera;

Step 505b: judging whether the intensity of light entering the second camera dims and then brightens; if yes, performing step 506b, and if no, performing step 505b;

Step 506b: judging whether the duration of dimming exceeds the second preset time; if yes, performing step 507b, and if no, performing step 505b;

Step 507b: the electronic device switches from the working mode using the second camera to the working mode using the first camera.

In step 501, as illustrated in FIG. 2, the electronic device 10 is in the shooting mode; the user aims at an object to be shot with the first camera and then presses the shooting key to obtain a photograph; in that case, the electronic device is still in the shooting mode.

In step 502, the electronic device 10 may detect the RGB values of pixels in an image formed at a built-in photosensitive element, the histogram or the gray scale map of the image formed at the photosensitive element, or the AE Level, so as to obtain the intensity of light entering the first camera. For example, the image of the electronic device has 1024×768 pixels, and the RGB values are calculated for each pixel of the image of the photosensitive element.

For example, as illustrated in FIG. 3, when the user shades the first camera with a palm 104 and the intensity of light entering the first camera dims, the RGB values are calculated for each pixel being shaded to count a percentage of the pixels having their R,G,B values all approximate to zero, or the percentage of the grey scales approximate to zero (i.e., the light dims) in the histogram of the image, and the duration of dimming.

For example, if the intensity of light dims in step 502, and 90% of the 1024×768 pixels have their R,G,B values all approximate to zero, or 90% of the grey scales approximate to zero in the histogram, performing step 503a; and if the duration of dimming exceeds the first preset time, performing step 504a.

In step 505a, for example as illustrated in FIG. 4, when the user removes the palm 104 shading the first camera and the intensity of light entering the first camera brightens, the RGB values are calculated for each pixel without being shaded to count a percentage of the pixels having their RGB values not all approximate to zero, or the percentage of the grey scales not approximating to zero (i.e., the light brightens) in the histogram of the image, and the duration of brightening.

For example, if the intensity of light brightens in step 505a, and 50% of the 1024×768 pixels have their R,G,B values not all approximate to zero, or 50% of the grey scales do not approximate to zero in the histogram, performing step 506a; and if the duration of brightening exceeds the first preset time, performing step 507a.

In this embodiment, the specific calculations in steps 502 and 505b for judging whether the light dims and then brightens may combine the above calculations for judging whether the light dims and brightens, respectively, and herein are omitted. To be noted, the detection of the intensity of light is just exemplarily described as above, and the present invention is not limited thereto. In this embodiment, steps 501-507a and 501-507b are implemented similarly to Embodiments 1 and 2, respectively, and herein are omitted.

In this embodiment, the first threshold, the second threshold, the first preset time and the second preset time may be set according to the actual requirement, e.g., on-demand in implementation or as desired or required for the current condition or implementation, which are not limited herein.

In this embodiment, the change of the intensity of light entering the first camera may be caused by the user by shading the first camera with his hand, or an opaque baffle, a wall, etc., which is not limited herein.

As can be seen from the above method of this embodiment, the intensity of light entering the first camera is detected through the electronic device; and when it is detected that the change of the intensity of light entering the first camera meets the preset condition, the electronic device switches the working mode, thereby simplifying the operation steps of the electronic device, and quickly and conveniently switching the working mode of the electronic device, such that the user obtains better experiences.

### Embodiment 4

Embodiment 4 of the present invention further provides an apparatus for controlling a working mode, which is applicable to an electronic device controlling a first camera. Since the apparatus solves problems in the same principle as the method of Embodiment 1, for its implementation please refer to that of the method of Embodiment 1, and the repeated contents are omitted herein.

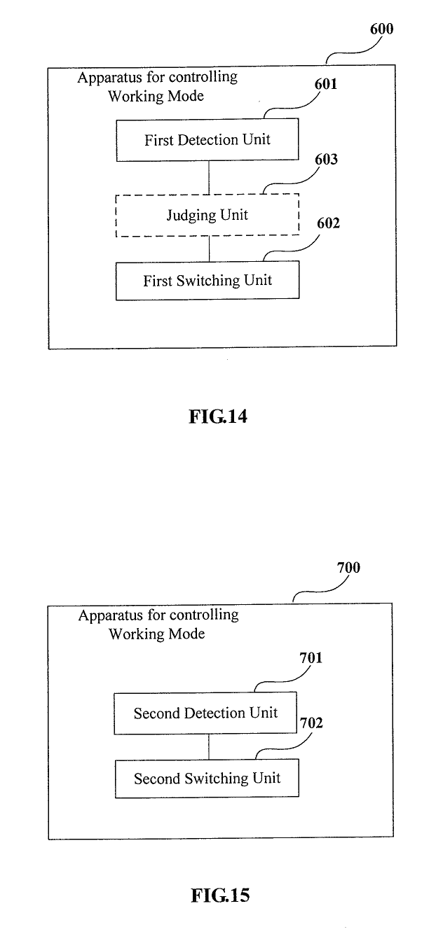

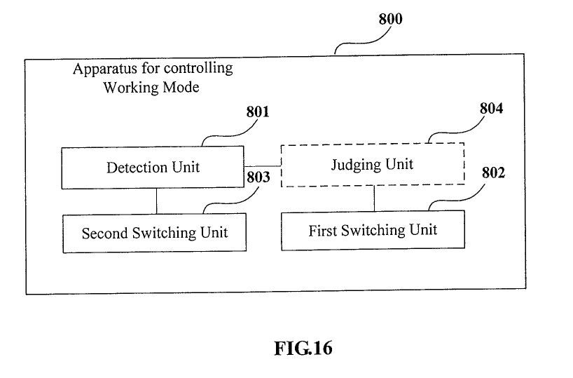

FIG. 14 is a structure diagram of an apparatus for controlling a working mode according to Embodiment 4 of the present invention. As illustrated in FIG. 14, the apparatus 600 includes a first detection unit 601 and a first switching unit 602, wherein,

the first detection unit 601 is configured to detect an intensity of light entering a first camera; and

the first switching unit 602 is configured to switch the working mode when detecting that a change of the intensity of light entering the first camera meets a first preset condition.

In this embodiment, the first detection unit 601 may detect RGB values of pixels in an image formed at a photosensitive element (e.g., CCD image sensor, CMOS image sensor, etc.), a histogram or a gray scale map of the image formed at the photosensitive element, or AE Level, so as to obtain the intensity of light entering the first camera. But in the embodiment, the detection of the intensity of light is not limited to the above way. For example, the intensity of light entering the first camera may also be detected by providing a dedicated optical sensor, and the specific way for the detection may be determined according to the actual situation.

In one embodiment, the first detection unit 601 detects that the change of the intensity of light entering the first camera meets the first preset condition means that the intensity of light entering the first camera dims and the intensity of light is lower than the first threshold; and when the electronic device is in the shooting mode, the first switching unit 602 is configured to switch the electronic device from the shooting mode to the review mode.

In another embodiment, the first detection unit 601 detects that the change of the intensity of light entering the first camera meets the first preset condition means that the intensity of light entering the first camera brightens and the intensity of light is higher than the second threshold; and when the electronic device is in the review mode, the first switching unit 602 is configured to switch the electronic device from the review mode to the shooting mode.

In this embodiment, in order to further improve the error-tolerance rate of the switching of the working mode, the apparatus may further include:

a judging unit 603 configured to judge whether the duration of the change of the intensity of light entering the first camera exceeds a first preset time; the first switching unit 602 is configured to switch the working mode, when the first detection unit 601 detects that the change of the intensity of light entering the first camera meets the first preset condition and the judging result of the judging unit 603 is Yes.

In this embodiment, the change of the intensity of light entering the first camera is caused by the user by shading the first camera with an opaque object.

In this embodiment, the first threshold, the second threshold and the first preset time may be set according to the actual requirement, e.g., on-demand in implementation or as desired or required for the current condition or implementation, which are not limited herein.

In this embodiment, the user may set different first preset conditions and the switching of the working mode according to the actual requirement, e.g., on-demand in implementation or as desired or required for the current condition or implementation, which are not limited herein.

As can be seen from the above apparatus of this embodiment, the intensity of light entering the first camera is detected; and when it is detected that the change of the intensity of light entering the first camera meets the preset condition, the electronic device switches between the shooting mode and the review mode, such that the user quickly and conveniently views the shot photographs during the shooting, and obtains better experiences.

### Embodiment 5

Embodiment 5 of the present invention further provides an apparatus for controlling a working mode, which is applicable to an electronic device controlling a first camera and a second camera.

Since the apparatus solves problems in the same principle as the method of Embodiment 2, for its implementation please refer to that of the method of Embodiment 2, and the repeated contents are omitted herein.

FIG. 15 is a structure diagram of an apparatus for controlling a working mode according to Embodiment 5 of the present invention. As illustrated in FIG. 15, the apparatus 700 includes a second detection unit 701 and a second switching unit 702, wherein,

The implementation of the second detection unit 701 is similar to that of the first detection unit 601 in Embodiment 4, and herein is omitted.

The second switching unit 702 is configured to switch the electronic device from the working mode using the first camera to the working mode using the second camera, when detecting that the change of the intensity of light entering the first camera meets the second preset condition.

In this embodiment, when the second detection unit 701 detects that the change of the intensity of light entering the first camera meets the second preset condition means that the intensity of light entering the first camera dims and then brightens and a duration of dimming exceeds a second preset time, the second switching unit 702 switches the electronic device from the working mode using the first camera to the working mode using the second camera.

In this embodiment, different thresholds may be set to judge whether the intensity of light entering the first camera dims and then brightens. For example, a third threshold and a fourth threshold may be set to judge that the intensity of light dims and then brightens when the intensity of light becomes lower than the third threshold and then higher than the fourth threshold and the duration of the intensity of light lower than the third threshold exceeds the second preset time.

The third threshold, the fourth threshold and the second preset time may be set according to the actual requirement, which are not limited herein.

In this embodiment, the change of the intensity of light entering the first camera may be caused by the user by shading the first camera with an opaque object, such as a hand, an opaque baffle, a wall, etc., which is not limited herein.

As can be seen from the above apparatus of this embodiment, the intensity of light entering the first camera is detected; and when it is detected that the change of the intensity of light entering the first camera meets the preset condition, the electronic device switches from the working mode using the first camera to the working mode using the second camera, thereby simplifying the operation steps of the electronic device, and quickly and conveniently switching between the cameras of the electronic device for a shooting, such that the user obtains better experiences.

### Embodiment 6

Embodiment 6 of the present invention further provides an apparatus for controlling a working mode, which is applicable to an electronic device controlling a first camera and a second camera. Since the apparatus solves problems in the same principle as the method of Embodiment 3, for its implementation please refer to that of the method of Embodiment 2, and the repeated contents are omitted herein.

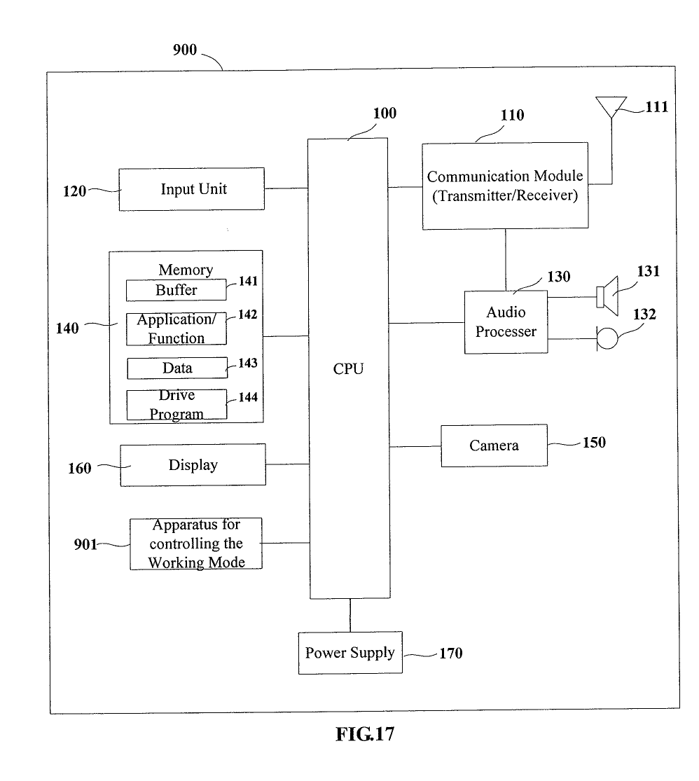

FIG. 16 is a structure diagram of an apparatus for controlling a working mode according to Embodiment 6 of the present invention. As illustrated in FIG. 16, the apparatus 800 includes a detection unit 801, a first switching unit 802 and a second switching unit 803, wherein,

the detection unit 801 can realize the functions of the first detection unit 601 and the second detection unit 701; the implementation and function of the first switching unit 802 are the same as those of the first switching unit 602 in Embodiment 4; and the implementation and function of the second switching unit 803 are the same as those of the second switching unit 702 in Embodiment 5. The contents of Embodiments 4 and 5 are incorporated herein, and the same contents are omitted.

In this embodiment, in order to further improve the error-tolerance rate of the switching of the working mode, the apparatus may further include:

a judging unit 804 configured to judge whether a duration of the change of the intensity of light entering the first camera exceeds a first preset time;

the first switching unit 802 is configured to switch the working mode, when the first detection unit 801 detects that the change of the intensity of light entering the first camera meets the first preset condition and the judging result of the judging unit 804 is Yes.

As can be seen from the above apparatus of this embodiment, the intensity of light entering the first camera is detected; and when it is detected that the change of the intensity of light entering the first camera meets the preset condition, the electronic device switches the working mode, thereby simplifying the operation steps of the electronic device, and quickly and conveniently switching the working mode of the electronic device, such that the user obtains better experiences.

### Embodiment 7

Embodiment 7 of the present invention provides an electronic device, which controls one or more cameras. The electronic device may be, but not limited to, a cellular phone, a photographic camera, a video camera, a tablet PC, etc.

In this embodiment, the electronic device may include the apparatus for controlling the working mode as described in Embodiment 4, 5, or 6, with their contents being incorporated herein, and the same contents are omitted. In this embodiment, the electronic device may be, but not limited to, a mobile terminal.

FIG. 17 is a block diagram of a system structure of an electronic device 900 according to an embodiment of the present invention, including an apparatus 901 for controlling a working mode. As illustrated in FIG. 17, the apparatus 901 for controlling the working mode may be connected to a central processing unit (CPU) 100. The apparatus 901 for controlling the working mode may be any of the apparatuses 600, 700 and 800. To be noted, the diagram is exemplary, and other type of structure may also be used to supplement or replace the structure, so as to realize the telecom function or other function.

As illustrated in FIG. 17, the electronic device 900 may include a CPU 100, a communication module 110, an input unit 120, an audio processing unit 130, a memory 140, a camera 150, a display 160 and a power supply 170.

The CPU 100 (sometimes called as controller or operation control, including microprocessor or other processor device and/or logic device) receives an input and controls respective parts and operations of the electronic device 900. The input unit 120 provides an input to the CPU 100. The input unit 120 for example is a key or a touch input device. The camera 150 captures image data and supplies the captured image data to the CPU 100 for a conventional usage, such as storage, transmission, etc.

The power supply 170 supplies electric power to the electronic device 100. The display 160 displays objects such as images and texts. The display may be, but not limited to, an LCD. The memory 140 is coupled to the CPU 100. The memory 140 may be a solid state memory, such as Read Only Memory (ROM), Random Access Memory (RAM), SIM card, etc., or a memory which stores information even if the power is off, which can be selectively erased and provided with more data, and the example of such a memory is sometimes called as EPROM etc. The memory 140 also may be a certain device of other type. The memory 140 includes a buffer memory 141 (sometimes called as buffer). The memory 140 may include an application/function storage section 142 which stores application programs and function programs or performs the operation procedure of the electronic device 900 via the CPU 100.

The memory 140 may further include a data storage section 143 which stores data such as contacts, digital data, pictures, sounds and/or any other data used by the electronic device. A drive program storage section 144 of the memory 140 may include various drive programs of the electronic device for performing the communication function and/or other functions (e.g., message transfer application, address book application, etc.) of the electronic device.

The communication module 110 is a transmitter/receiver 110 which transmits and receives signals via an antenna 111. The communication module (transmitter/receiver) 110 is coupled to the CPU 100, so as to provide an input signal and receive an output signal, which may be the same as the situation of conventional mobile communication terminal.

Based on different communication technologies, the same electronic device may be provided with a plurality of communication modules 110, such as cellular network module, Bluetooth module and/or wireless local area network (WLAN) module. The communication module (transmitter/receiver) 110 is further coupled to a speaker 131 and a microphone 132 via an audio processor 130, so as to provide an audio output via the speaker 131, and receive an audio input from the microphone 132, thereby performing the normal telecom function. The audio processor 130 may include any suitable buffer, decoder, amplifier, etc. In addition, the audio processor 130 is further coupled to the CPU 100, so as to locally record sound through the microphone 132, and play the locally stored sound through the speaker 131.

The embodiment of the present invention further provides a computer readable program, which when being executed in an electronic device, enables a computer to perform the method for controlling the working mode according to Embodiment 1, 2 or 3 in the electronic device.

The embodiment of the present invention further provides a storage medium storing a computer readable program, wherein the computer readable program enables a computer to perform the method for controlling the working mode according to Embodiment 1, 2 or 3 in an electronic device.

The preferred embodiments of the present invention are described as above with reference to the drawings. Many features and advantages of those embodiments are apparent from the detailed Specification, thus the accompanied claims intend to cover all such features and advantages of those embodiments which fall within the true spirit and scope thereof. In addition, since numerous modifications and changes are easily conceivable to a person skilled in the art, the embodiments of the present invention are not limited to the exact structures and operations as illustrated and described, but cover all suitable modifications and equivalents falling within the scope thereof.

It shall be understood that each of the parts of the present invention may be implemented by hardware, software, firmware, or combinations thereof. In the above embodiments, multiple steps or methods may be implemented by software or firmware stored in the memory and executed by an appropriate instruction executing system. For example, if the implementation uses hardware, it may be realized by any one of the following technologies known in the art or combinations thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

Any process, method or block in the flowchart or described in other manners herein may be understood as being indicative of including one or more modules, segments or parts for realizing the codes of executable instructions of the steps in specific logic functions or processes, and that the scope of the preferred embodiments of the present invention include other implementations, wherein the functions may be executed in manners different from those shown or discussed (e.g., according to the related functions in a substantially simultaneous manner or in a reverse order), which shall be understood by a person skilled in the art.

The logic and/or steps shown in the flowcharts or described in other manners here may be, for example, understood as a sequencing list of executable instructions for realizing logic functions, which may be implemented in any computer readable medium, for use by an instruction executing system, apparatus or device (such as a system based on a computer, a system including a processor, or other systems capable of extracting instructions from an instruction executing system, apparatus or device and executing the instructions), or for use in combination with the instruction executing system, apparatus or device.

The above literal descriptions and drawings show various features of the present invention. It shall be understood that a person of ordinary skill in the art may prepare suitable computer codes to carry out each of the steps and processes described above and illustrated in the drawings. It shall also be understood that the above-described terminals, computers, servers, and networks, etc. may be any type, and the computer codes may be prepared according to the disclosure contained herein to carry out the present invention by using the apparatus.

Particular embodiments of the present invention have been disclosed herein. A person skilled in the art will readily recognize that the present invention is applicable in other environments. In practice, there exist many embodiments and implementations. The appended claims are by no means intended to limit the scope of the present invention to the above particular embodiments. Furthermore, any reference to “an apparatus configured to . . . ” is an explanation of apparatus plus function for describing elements and claims, and it is not desired that any element using no reference to “an apparatus configured to . . . ” is understood as an element of apparatus plus function, even though the wording of “apparatus” is included in that claim.

Although a particular preferred embodiment or embodiments have been shown and the present invention has been described, it will be appreciated that equivalent modifications and variants are conceivable to a person skilled in the art in reading and understanding the description and drawings. Especially for various functions executed by the above elements (parts, components, apparatus, and compositions, etc.), except otherwise specified, it is desirable that the terms (including the reference to “apparatus”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

1. A method for controlling a working mode, comprising:
detecting, by an electronic device, an intensity of light entering a first camera; and
switching, by the electronic device, the working mode, when detecting that a change of the intensity of light entering the first camera meets a first preset condition.

2. The method according to claim 1, wherein the change of the intensity of light entering the first camera meets the first preset condition comprises: the intensity of light entering the first camera dims and the intensity of light is lower than a first threshold;
the electronic device is in a shooting mode; switching, by the electronic device, the working mode comprises: switching, by the electronic device, from the shooting mode to a review mode.

3. The method according to claim 1, wherein the change of the intensity of light entering the first camera meets the first preset condition comprises: the intensity of light entering the first camera brightens and the intensity of light is higher than a second threshold;
the electronic device is in a review mode; switching, by the electronic device, the working mode comprises: switching, by the electronic device, from the review mode to a shooting mode.

4. The method according to claim 1, wherein detecting, by the electronic device, the intensity of light entering the first camera comprises:
detecting, by the electronic device, RGB values of pixels in an image formed at a photosensitive element, a histogram or a gray scale map of the image formed at the photosensitive element, or Auto Exposure (AE) level, so as to obtain the intensity of light entering the first camera.

5. The method according to claim 1, further comprising:
judging, by the electronic device, whether a duration of the change of the intensity of light entering the first camera exceeds a first preset time; and
switching, by the electronic device, the working mode, when detecting that the change of the intensity of light entering the first camera meets the first preset condition, and the duration of the change of the intensity of light exceeds the first preset time.

6. The method according to claim 1, wherein the change of the intensity of light entering the first camera is caused by the user by shading the first camera with an opaque object.

7. The method according to claim 1, further comprising:
switching, by the electronic device, from the working mode using the first camera to a working mode using a second camera, when detecting that the change of the intensity of light entering the first camera meets a second preset condition.

8. The method according to claim 7, wherein the change of the intensity of light entering the first camera meets the second preset condition comprises: the intensity of light entering the first camera dims and then brightens, and a duration of dimming exceeds a second preset time.

9. A method for controlling a working mode, comprising:
detecting, by an electronic device, an intensity of light entering a first camera; and
switching, by the electronic device, from the working mode using the first camera to a working mode using a second camera, when detecting that a change of the intensity of light entering the first camera meets a preset condition.

10. The method according to claim 9, wherein the change of the intensity of light entering the first camera meets the preset condition comprises: the intensity of light entering the first camera dims and then brightens, and the duration of dimming exceeds a preset time.

11. An apparatus for controlling a working mode, comprising:
a first detection unit configured to detect an intensity of light entering a first camera; and
a first switching unit configured to switch the working mode when detecting that a change of the intensity of light entering the first camera meets a first preset condition.

12. The apparatus according to claim 11, wherein when the first detection unit detects that the change of the intensity of light entering the first camera meets the first preset condition means that the intensity of light entering the first camera dims and the intensity of light is lower than a first threshold, and the electronic device is in a shooting mode, the first switching unit is configured to switch the electronic device from the shooting mode to a review mode.

13. The apparatus according to claim 11, wherein when the first detection unit detects that the change of the intensity of light entering the first camera meets the first preset condition means that the intensity of light entering the first camera brightens and the intensity of light is higher than a second threshold, and the electronic device is in a review mode, the first switching unit is configured to switch the electronic device from the review mode to a shooting mode.

14. The apparatus according to claim 11, wherein the first detection unit detects RGB values of pixels in an image formed at a photosensitive element, a histogram or a gray scale map of the image formed at the photosensitive element, or Auto Exposure (AE) level, so as to obtain the intensity of light entering the first camera.

15. The apparatus according to claim 11, further comprising:
a judging unit configured to judge whether a duration of the change of the intensity of light entering the first camera exceeds a first preset time;
the first switching unit is further configured to switch the working mode, when the first detection unit detects that the change of the intensity of light entering the first camera meets the first preset condition and a judging result of the judging unit is Yes.

16. The apparatus according to claim 11, further comprising:
a second switching unit configured to switch the electronic device from the working mode using the first camera to a working mode using a second camera, when detecting that the change of the intensity of light entering the first camera meets a second preset condition.

17. The apparatus according to claim 16, wherein the change of the intensity of light entering the first camera meets the second preset condition comprises: the intensity of light entering the first camera dims and then brightens, and a duration of dimming exceeds a second preset time.

18. An apparatus for controlling a working mode, comprising:
a detection unit configured to detect an intensity of light entering a first camera; and
a switching unit configured to switch the electronic device from the working mode using the first camera to a working mode using a second camera, when the detection unit detects that a change of the intensity of light entering the first camera meets a preset condition.

19. The apparatus according to claim 18, wherein the change of the intensity of light entering the first camera meets the preset condition comprises: the intensity of light entering the first camera dims and then brightens, and a duration of dimming exceeds a preset time.

20. An electronic device, further comprising the apparatus for the controlling a working mode control according to claim 11.
